(19) United States
(12) Patent Application Publication
(10) Pub. No.: US 2023/0144301 A1
(43) Pub. Date: May 11, 2023

(54) IMAGE DISPLAY ELEMENT AND DRAWING BODY

(71) Applicant: SONY GROUP CORPORATION, TOKYO (JP)

(72) Inventor: TAKEHISA ISHIDA, TOKYO (JP)

(21) Appl. No.: 17/905,485

(22) PCT Filed: Mar. 4, 2021
(86) PCT No.: PCT/JP2021/008481

§ 371 Date: Sep. 1, 2022

(30) Foreign Application Priority Data
Mar. 9, 2020 (JP) 2020-039909

(51) Int. Cl. B41M 3/14; B42D 25/23; B42D 25/351; B42D 25/382; B42D 25/41; B42D 25/47

(52) U.S. Cl. CPC B41M 3/148; B42D 25/23; B42D 25/351; B42D 25/382; B42D 25/41; B42D 25/47

(57) ABSTRACT

An image display element includes a display layer configured to display first to n-th (where n is an integer of 2 or more) images; a light-shielding pattern layer disposed opposite to the display layer and having alternately disposed light-shielding parts and light-transmitting parts, and a transparent layer disposed between the display layer and the light-shielding pattern layer. The display layer contains a coloring matter, where the coloring matter forms first to n-th images; each of the first to n-th images is divided in a discrete manner corresponding to the arrangement pattern of the light-transmitting parts; and an image visible through the light-shielding pattern layer changes depending on the angle from which the light-shielding pattern layer is viewed.

### TECHNICAL FIELD

The present disclosure relates to an image display element and a drawing body.

### BACKGROUND ART

In recent years, image display elements have been used on important documents and cards to make counterfeiting difficult and to enable easy judgments of authenticity. As such image display elements, hologram elements and display elements provided with a lenticular lens on the displayed image part have been proposed. A parallax barrier type variable display element using a striped light-shielding pattern has also been proposed (see, for example, PTL 1).

### CITATION LIST

### Patent Literature

[PTL 1]

JP 2005-134718 A

### SUMMARY

### Technical Problem

As mentioned above, image display elements that make it difficult to counterfeit documents, cards, and the like and enable easy judgment of their authenticity have become desirable in recent years.

An object of the present disclosure is to provide an image display element and a drawing body that make counterfeiting difficult and can be easily judge the authenticity.

### Solution to Problem

In order to solve the problem described above, a first disclosure is an image display element, including:

a display layer configured to display first to n-th (where n is an integer of 2 or more) images;

a light-shielding pattern layer disposed opposite to the display layer and having alternately disposed light-shielding parts and light-transmitting parts; and

a transparent layer disposed between the display layer and the light-shielding pattern layer, wherein

the display layer contains a coloring matter, where the coloring matter forms first to n-th images;

each of the first to n-th images is divided in a discrete manner corresponding to the arrangement pattern of the light-transmitting parts; and

an image visible through the light-shielding pattern layer changes depending on the angle from which the light-shielding pattern layer is viewed.

A second disclosure is an image display element including:

a display layer configured to display first to n-th (where n is an integer of 2 or more) images;

a light-shielding pattern layer disposed opposite to the display layer and having alternately disposed light-shielding parts and light-transmitting parts; and

a transparent layer disposed between the display layer and the light-shielding pattern layer, wherein

at least one of the display layer and the light-shielding pattern layer contains a coloring matter;

if the display layer contains the coloring matter, the coloring matter forms first to n-th images;

if the light-shielding pattern layer contains the coloring matter, the coloring matter forms the light-shielding parts;

each of the first to n-th images is divided in a discrete manner corresponding to the arrangement pattern of the light-transmitting parts; and

an image visible through the light-shielding pattern layer changes depending on the angle from which the light-shielding pattern layer is viewed.

A third disclosure is an image display element including:

a display layer;

a light-shielding pattern layer disposed opposite to the display layer and having alternately disposed light-shielding parts and light-transmitting parts; and

a first transparent layer disposed between the display layer and the light-shielding pattern layer, wherein

the display layer includes:

a first display layer configured to display a first image;

a second display layer disposed opposite to the first display layer and configured to display a second image; and

a second transparent layer disposed between the first display layer and the second display layer, wherein

the first display layer and the second display layer each contain a coloring matter, where the coloring matter forms a first image and the second image;

each of the first and second images is divided in a discrete manner corresponding to the arrangement pattern of the light-transmitting parts; and

an image visible through the light-shielding pattern layer changes depending on the angle from which the light-shielding pattern layer is viewed.

A fourth disclosure is a drawing body including:

a first recording layer;

a second recording layer disposed opposite to the first recording layer;

a transparent layer disposed between the first recording layer and the second recording layer, wherein

the first recording layer includes a display part configured to display first to n-th (where n is an integer of 2 or more) images;

the first recording layer contains a coloring matter, where the coloring matter forms first to n-th images;

the second recording layer includes a light-shielding pattern part disposed opposite to the display part and having alternately disposed light-shielding parts and light-transmitting parts;

each of the first to n-th images is divided in a discrete manner corresponding to the arrangement pattern of the light-transmitting parts; and

an image visible through the light-shielding pattern part changes depending on the angle from which the light-shielding pattern part is viewed.

A fifth disclosure is a drawing body including:

a first recording layer;

a second recording layer disposed opposite to the first recording layer;

a transparent layer disposed between the first recording layer and the second recording layer, wherein

the first recording layer includes a display part configured to display first to n-th (where n is an integer of 2 or more) images;

the second recording layer includes a light-shielding pattern part disposed opposite to the display part and having alternately disposed light-shielding parts and light-transmitting parts;

at least one of the first recording layer and the second recording layer contains a coloring matter;

if the first recording layer contains a coloring matter, the coloring matter forms first to n-th images;

if the second recording layer contains a coloring matter, the coloring matter forms the light-shielding parts;

each of the first to n-th images is divided in a discrete manner corresponding to the arrangement pattern of the light-transmitting parts; and

an image visible through the light-shielding pattern part changes depending on the angle from which the light-shielding pattern part is viewed.

### BRIEF DESCRIPTION OF DRAWINGS

FIG. 1 is an exploded perspective view illustrating an example of the constitution of the image display element according to the first embodiment of the present disclosure.

FIG. 2 is a cross-sectional view illustrating an example of a constitution of the image display element according to the first embodiment of the present disclosure.

FIG. 3 is a plan view illustrating an example of a constitution of a display layer.

FIGS. 4A and 4B are sectional views for describing an example of the method for manufacturing the image display element according to the first embodiment of the present disclosure.

FIG. 5 is a cross-sectional view illustrating an example of a constitution of the image display element according to the second embodiment of the present disclosure.

FIG. 6 is a cross-sectional view for describing the principle of the multicolor display of a display layer.

FIGS. 7A and 7B are sectional views for describing an example of the method for manufacturing the image display element according to the second embodiment of the present disclosure.

FIG. 8 is a cross-sectional view illustrating an example of the constitution of the image display element according to the third embodiment of the present disclosure.

FIG. 9 is a cross-sectional view illustrating an example of the constitution of the image display element according to the fourth embodiment of the present disclosure.

FIG. 10A is a plan view illustrating an example of a constitution of a first display layer. FIG. 10B is a plan view illustrating an example of the constitution of a second display layer.

FIGS. 11A and 11B are sectional views for describing an example of the method for manufacturing the image display element according to the fourth embodiment of the present disclosure.

FIG. 12 is a cross-sectional view illustrating an example of the constitution of the image display element according to the fifth embodiment of the present disclosure.

FIG. 13 is a cross-sectional view illustrating an example of the constitution of the image display element according to the sixth embodiment of the present disclosure.

FIG. 14A is a plan view illustrating an example of the constitution of a light-shielding pattern layer. FIG. 14B is a plan view illustrating an example of the constitution of a display layer.

FIGS. 15A and 15B are plan views each illustrating a modification example of a light-shielding pattern layer.

FIGS. 16A and 16B are plan views each illustrating a modification example of a light-shielding pattern layer.

FIG. 17A is a plan view illustrating an example of the constitution of the card according to the seventh embodiment of the present disclosure. FIG. 17B is a cross-sectional view along the line XVIIB-XVIIB in FIG. 17A.

FIG. 18 is a cross-sectional view illustrating an example of the constitution of the card according to the eighth embodiment of the present disclosure.

FIG. 19 is a cross-sectional view illustrating an example of the constitution of the image display element according to Modification Example 1.

### DESCRIPTION OF EMBODIMENTS

Embodiments of the present disclosure will be described in the following order with reference to the drawings. Here, in all the drawings of the following embodiments, the same or corresponding parts will be denoted with the same reference numerals.

1 First Embodiment (Example of Image Display Element)

2 Second Embodiment (Example of Image Display Element)

3 Third Embodiment (Example of Image Display Element)

4 Fourth Embodiment (Example of Image Display Element)

5 Fifth Embodiment (Example of Image Display Element)

6 Sixth Embodiment (Example of Image Display Element)

7 Seventh Embodiment (Example of Card)

8 Eighth Embodiment (Example of Card)

9 Modification Example

### 1 FIRST EMBODIMENT

[Constitution of Image Display Element]

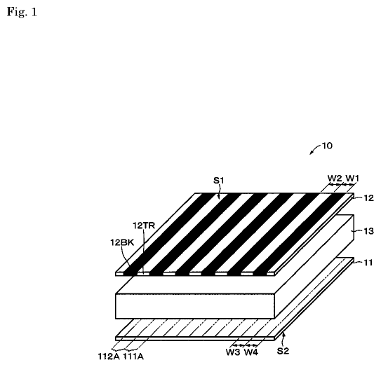

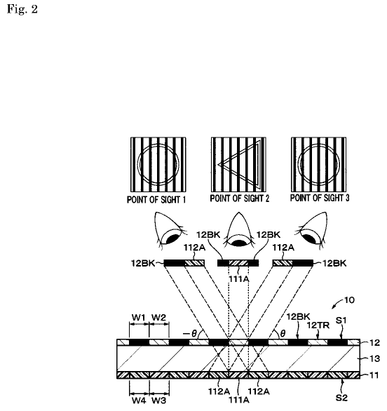

FIG. 1 is an exploded perspective view illustrating an example of the constitution of the image display element 10 according to the first embodiment of the present disclosure. FIG. 2 is a cross-sectional view illustrating an example of a constitution of the image display element 10 according to the first embodiment of the present disclosure. The image display element 10 includes a display layer 11, a light-shielding pattern layer 12, and a transparent layer 13. The light-shielding pattern layer 12 is disposed opposite to the display layer 11. The transparent layer 13 is disposed between the display layer 11 and the light-shielding pattern layer 12. The image display element 10 has a film or plate shape, and a first surface on the side where the light-shielding pattern layer 12 is disposed is the display surface S1 of the displayed image, and a second surface on which the display layer 11 is provided is the back surface S2. Hereinafter, the direction perpendicular to the display surface S1 is referred to as the “vertical direction”, and the oblique direction with a specified angle ±θ based on this vertical direction is referred to as the “oblique direction with a specified angle ±θ”.

(Display Layer)

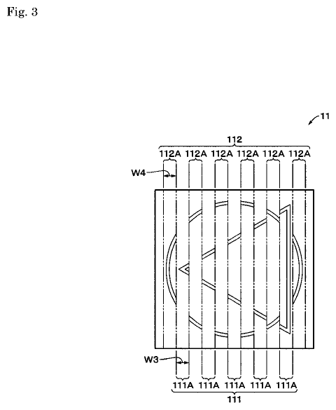

FIG. 3 is a plan view illustrating an example of a constitution of the display layer 11. The display layer 11 displays a first image 111 and a second image 112. For example, the first image 111 and the second image 112 have the same hue. The first image 111 and the second image 112 are divided into discrete image elements 111A and image elements 112A, respectively, corresponding to the arrangement pattern of the light-transmitting parts 12TR of the light-shielding pattern layer 12. The image elements 111A of the first image 111 and the image elements 112A of the second image 112 are arranged repeatedly in the order of the image elements 111A of the first image 111 and the image elements 112A of the second image 112. That is, the image elements 111A of the first image 111 and the image elements 112A of the second image 112 are arranged alternately. The image elements 111A and 112A have substantially belt-like shapes. The arrangement pattern of the image elements 111A and the image elements 112A are each the same as the arrangement pattern (that is, a striped arrangement pattern) of the light-transmitting parts 12TR of the light-shielding pattern layer 12.

The display layer 11 has a flat surface. As described below, the display layer 11 has a flat surface because the display layer 11 is formed by irradiating a recording layer with a substantially constant thickness with a laser beam.

The display layer 11 contains a coloring matter, and this coloring matter forms the first image 111 and the second image 112. The display layer 11 is preferably composed of a material that enables stable recording and control of the color-developed state. Specifically, the display layer 11 preferably contains an electron-donating coloring matter and an electron-accepting-material. The coloring reaction occurs between the electron-donating coloring matter and the electron-accepting material by external stimuli (irradiation with a laser beam), resulting in the development of color in the irradiated part. The first image 111 and the second image 112 are formed in this way. The display layer 11 preferably contains a photothermal conversion material or a polymer material, and more preferably contains both these materials. The display layer 11 may contain various additives, such as sensitizers and UV absorbers, in addition to the above material. The thickness of the display layer 11 is, for example, 1 μm or more and 10 μm or less.

The reaction between the electron-donating coloring matter and the electron-accepting material is, for example, reversible. When the electron-donating coloring matter is in a color-developed state, the first image 111 and the second image 112 are formed, and when the electron-donating coloring matter is in a decolorized state, the first image 111 and the second image 112 disappear.

Examples of electron-donating coloring matters include leuco dyes. Examples of leuco dyes include existing dyes for thermal papers. Specifically, a compound containing an electron-donating group in a molecule, represented by the following formula (1), may be mentioned as an example.

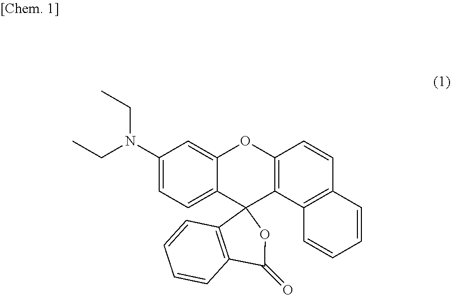 [SMILES: CCN(CC)c1ccc2c(c1)Oc1ccc3ccccc3c1C21OC(=O)c2ccccc21]

An electron-accepting material is a color developing/reducing reagent of electron-donating coloring matters. For example, an electron-accepting material develops colors of a colorless electron-donating coloring matter or discolors an electron-donating coloring matter that develops a prescribed color. Examples of color developing/reducing reagents include compounds having a salicylic acid skeleton represented by the formula (2) below and containing a group with an electron-accepting ability in a molecule.

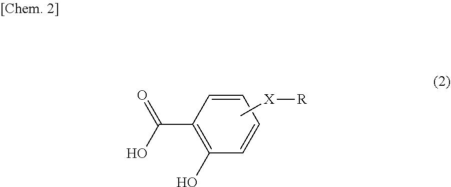

(X denotes one of —NHCO—, —CONH—, —NHCONH—, —CONHCO—, —NHNHCO—, —CONHNH—, —CONHNHCO—, —NHCOCONH—, —NHCONHCO—, —CONHCONH—, —NHNHCONH—, —NHCONHNH—, —CONHNHCONH—, —NHCONHNHCO—, and —CONHNHCONH—. R is a linear hydrocarbon group having a carbon number of 25 or more and 34 or less.)

For example, a photothermal conversion material absorbs light within a prescribed wavelength range in a near-infrared area and generates heat. As a photothermal conversion material, a near-infrared ray-absorbing coloring matter that has an absorption peak within the range of, for example, 700 nm or more and 2000 nm or less, and absorbs almost no light in the visible region. Specifically, for example, compounds having a phthalocyanine skeleton (phthalocyanine dyes), compounds having a squarylium skeleton (squarylium dyes), and, for example, inorganic compounds and the like may be mentioned. Examples of inorganic compounds include metal complexes such as dithio complexes, diimonium salts, aminium salts, inorganic compounds, and the like. Examples of inorganic compounds include graphite, carbon black, metal powder particles, metal oxides such as tricobalt tetroxide, iron oxide, chromium oxide, copper oxide, titanium black, and ITO (Indium Tin Oxide), metal nitrides such as niobium nitride, metal carbides such as tantalum carbide, metal sulfides, various types of magnetic powder, and the like. In addition, a compound having a cyanine skeleton (cyanine dye) with excellent light and heat resistance may be used. It should be noted that the excellent light resistance herein means that a compound does not decompose during irradiation with a laser beam. The excellent heat resistance herein means that a 20% or more change in the maximum absorption peak value of the absorption spectrum does not occur, for example, when a film is formed with a polymer material and stored at 150° C. for 30 minutes. Examples of such compounds having a cyanine skeleton include a compound having at least one of a counter ion among SbF₆, PF₆, BF₄, ClO₄, CF₃SO₃ and (CF₃SO₃)₂N, and a methine chain containing a five-membered or six-membered ring. It should be noted that a compound having a cyanine skeleton used for the image display element 10 according to the first embodiment preferably includes both one of the counter ions mentioned above and a cyclic structure, such as five-membered and six-membered rings, in a methine chain, but if the compound includes at least one of these, sufficient light and heat resistance can be assured.

The polymer material preferably has a function as a binder. A polymer material that enables uniform dispersion of an electron-donating coloring matter, a color developing/reducing reagent, and a photothermal conversion material is preferable. Examples of polymer materials include at least one of thermosetting resins and thermoplastic resins. Specific examples thereof include at least one selected from the group consisting of polyvinyl chloride, polyvinyl acetate, vinyl chloride-vinyl acetate copolymers, ethyl cellulose, polystyrene, styrene copolymers, phenoxy resins, polyesters, aromatic polyesters, polyurethanes, polycarbonates, polyacrylic esters, polymethacrylates, acrylate copolymers, maleate copolymers, polyvinyl alcohol, modified polyvinyl alcohols, hydroxyethyl cellulose, carboxymethyl cellulose, starch, and the like.

(Light-Shielding Pattern Layer)

The light-shielding pattern layer 12 is for partially light-shielding the display layer 11 with a light-shielding pattern and changing images displayed by the display layer 11 depending on the angle from which the display surface S1 is viewed (that is, the angle from which the light-shielding pattern layer 12 is viewed). The light-shielding pattern layer 12 has alternately disposed light-shielding parts 12BK and light-transmitting parts 12TR. The light-shielding parts 12BK and light-transmitting parts 12TR have substantially belt-like shapes. The light-shielding parts 12BK and the light-transmitting parts 12TR are arranged in a regular arrangement pattern. In the first embodiment, a case where the regular arrangement pattern of the light-shielding parts 12BK and the light-transmitting parts 12TR is a striped arrangement pattern is explained.

The light-shielding pattern layer 12 has a flat surface. As described below, the light-shielding pattern layer 12 has a flat surface because the light-shielding pattern layer 12 is formed by irradiating a recording layer with a substantially constant thickness with a laser beam.

The light-shielding parts 12BK are for light-shielding the light that is incident on the display surface S1, the light reflected on the display layer 11, and the like. The light-shielding parts 12BK are disposed opposite to the image elements 112A. In the first embodiment, a case where almost whole of the light-shielding parts 12BK and the image elements 112A overlap in the thickness direction of the image display element 10 is explained, but some of the light-shielding parts 12BK and the image elements 112A may overlap in the thickness direction of the image display element 10. The color of the light-shielding parts 12BK is, for example, black, but it is not limited to black as long as it is capable of shielding light.

The light-transmitting parts 12TR are for allowing the light that is incident on the display surface S1 and the light reflected on the display layer 11 or the like to pass through. The light-transmitting parts 12TR are disposed opposite to the image elements 111A. In the first embodiment, a case where almost whole of the light-transmitting parts 12TR and the image elements 111A overlap in the thickness direction of the image display element 10 is explained, but some of the light-transmitting parts 12TR and the image elements 111A may overlap in the thickness direction of the image display element 10.

When the display surface S1 is viewed from the vertical direction, image elements 111A (that is, a first image 111) can be seen through light-transmitting parts 12TR (see the point of sight 2 in FIG. 2). When the display surface S1 is viewed from the oblique direction with a specified angle ±θ, image elements 112A (that is, a second image 112) can be seen through light-transmitting parts 12TR (see the points of sight 1 and 3 in FIG. 2).

The image elements 111A have substantially the same width as the light-transmitting parts 12TR. The term “substantially the same width” herein means that the ratio (W2:W3) between the width W2 of a light-transmitting part 12TR and the width W3 of an image element 111A is within the range of 1:0.9 to 1:1.1. In the present description, the term “to (˜)” indicating a numerical range is used in the sense that the range includes the numerical values listed before and after the “to (˜)” as the lower and upper limits.

The image elements 112A have substantially the same width as the light-transmitting parts 12TR. The term “substantially the same width” herein means that the ratio (W2:W4) between the width W2 of a light-transmitting part 12TR and the width W4 of an image element 112A is within the range of 1:0.9 to 1:1.1.

The ratio (W1:W2) between the width W1 of a light-shielding part 12BK and the width W2 of a light-transmitting part 12TR is preferably about 1:1, specifically 1:0.9 to 1:1.1. The thickness of the light-shielding pattern layer 12 is, for example, 1 μm or more and 50 μm or less.

The light-shielding pattern layer 12 contains a coloring matter, and this coloring matter forms the light-shielding parts 12BK. The light-shielding pattern layer 12 is preferably composed of a material that enables stable recording and control of the color-developed state. Specifically, the light-shielding pattern layer 12 preferably contains an electron-donating coloring matter and an electron-accepting material. The coloring reaction occurs between the electron-donating coloring matter and the electron-accepting material by external stimuli (irradiation with a laser beam), resulting in the development of color in the irradiated part. The light-shielding parts 12BK are formed in this way. The light-shielding pattern layer 12 preferably contains a photothermal conversion material or a polymer material, and more preferably contains both these materials. The photothermal conversion material in the display layer 11 and the photothermal conversion material in the light-shielding pattern layer 12 preferably have mutually different absorption wavelengths. This enables the color of the desired layer among the display layer 11 and the light-shielding pattern layer 12 to be selectively developed or reduced with a laser beam. The light-shielding pattern layer 12 may contain various additives such as sensitizers and UV absorbers in addition to the above material. The thickness of the light-shielding pattern layer 12 is, for example, 1 μm or more and 50 μm or less.

The reaction between the electron-donating coloring matter and the electron-accepting material is, for example, reversible. When the electron-donating coloring matter is in a color-developed state, the light-shielding parts 12BK are formed, and when the electron-donating coloring matter is in a decolorized state, the light-shielding parts 12BK disappear. The light-shielding parts 12BK contain an electron-donating coloring matter in a color-developed state. Meanwhile, the light-transmitting parts 12TR contain an electron-donating coloring matter in a decolorized state.

The same materials as the display layer 11 may be mentioned as examples of each of the electron-donating coloring matter, the electron-accepting material, the photothermal conversion material, and the polymer material.

(Transparent Layer)

The transparent layer 13 is for separating the space between the display layer 11 and the light-shielding pattern layer 12 and for supporting the display layer 11 and the light-shielding pattern layer 12. For example, the transparent layer 13 is a transparent film. The thickness of the transparent layer 13 is, for example, 50 μm or more and 600 μm or less. The transparent layer 13 is constituted such that the light that has passed through the light-transmitting parts 12TR and the light that has been reflected on the display layer 11 or the like are allowed to pass through. For example, the transparent layer 13 is transparent in the near-infrared and visible regions.

For example, the transparent layer 13 contains glass or a polymer resin.

Examples of polymer resins include:

at least one selected from the group consisting of triacetyl cellulose (TAC), polyester (TPEE), polyethylene terephthalate (PET), polyethylene naphthalate (PEN), polyimide (PI), polyamide (PA), aramid, polyethylene (PE), polyacrylate, polyethersulfone, polysulfone, polypropylene (PP) diacetyl cellulose, polyvinyl chloride, acrylic resins (PMMA), polycarbonate (PC), epoxy resins, urea resins, urethane resins, melamine resins, cycloolefin polymers (COP), and the like.

[Method for Manufacturing Image Display Element]

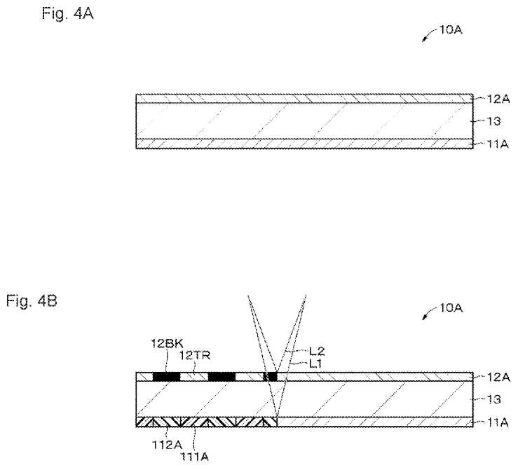

Hereinafter, an example of a method for manufacturing an image display element 10 according to the first embodiment of the present disclosure will be described with reference to FIGS. 4A and 4B.

(Step of Forming Laminate Body)

A laminate body 10A illustrated in FIG. 4A is formed in the following way. First, a polymer material is dissolved in a solvent (for example, methyl ethyl ketone). Next, an electron-donating coloring matter, an electron-accepting material, and a photothermal conversion material are added to this solution and dispersed. A coating material for forming recording layers is obtained in this way. Subsequently, this coating material for forming recording layers is coated on a first surface of a transparent layer 13 with a thickness of, for example, 3 μm and dried at, for example, 70° C. A first recording layer 11A is formed in this way.

Next, a second recording layer 12A is formed on a second surface of the transparent layer 13, in the same manner as the step of forming the first recording layer. A laminate body 10A is formed in this way. It should be noted that a material different from that used in the step of forming the first recording layer 11A is used as a photothermal conversion material. Materials that are different from or the same as those used in the step of forming the first recording layer 11A may be used as the electron-donating coloring matter and the electron-accepting material.

The laminate body 10A may be formed using a method other than the coating described above. For example, the first recording layer 11A and the second recording layer 12A may be formed in advance on separate substrates, respectively, and laminated on the first surface and the second surface of the transparent layer 13, respectively, via adhesive layers.

(Drawing Step of Images and Light-Shielding Parts)

The desired positions of the first recording layer 11A and the second recording layer 12A are respectively irradiated with a near-infrared laser beam L1 and a near-infrared laser beam L2 with adjusted wavelengths and outputs, as illustrated in FIG. 4B, by, for example, a semiconductor laser or the like. This causes the generation of heat from photothermal conversion materials in the first recording layer 11A and the second recording layer 12A and a coloring reaction (color developing reaction) between the electron-donating coloring matter and the electron-accepting material, resulting in the development of color in the irradiated area. A first image 111 and a second image 112 are formed on the first recording layer 11A in this way, and a display layer 11 is obtained. Furthermore, light-shielding parts 12BK and the light-transmitting parts 12TR are formed on the second recording layer 12A, and a light-shielding pattern layer 12 is obtained.

As illustrated in FIG. 4B, it is preferred to irradiate the first recording layer 11A and the second recording layer 12A with the laser beam L1 and the laser beam L2, respectively, while aligning the optical axes of the laser beam L1 and the laser beam L2. By controlling the irradiation with the laser beam L1 and the laser beam L2 in this way, it is no longer necessary to align the optical axes of the laser beam L1 and the laser beam L2, respectively, when drawing the first recording layer 11A and the second recording layer 12A. Furthermore, the misalignment of the light-shielding parts 12BK, the light-transmitting parts 12TR, the image elements 111A, and the image elements 112A can be suppressed. Since a transparent layer 13 is thin, the focal points of the laser beam L1 and the laser beam L2 may be substantially coincident.

However, the way of irradiation with the laser beam L1 and the laser beam L2 is not limited to the way of the examples described above. For example, the first recording layer 11A and the second recording layer 12A may be irradiated with the laser beam L1 and the laser beam L2, respectively, while shifting the optical axes of the laser beam L1 and the laser beam L2. Alternatively, the laser beam L1 and the laser beam L2 may be incident obliquely on the first recording layer 11A and the second recording layer 12A, respectively.

The image of the display layer 11 and the light-shielding pattern of the light-shielding pattern layer 12 may be rewritten. When the image on the display layer 11 and the light-shielding pattern on the light-shielding pattern layer 12 are to be decolorized, the display layer 11 and the light-shielding pattern layer 12 are irradiated with a near-infrared laser beam with enough energy to reach the decolorization temperature. This causes the generation of heat from the photothermal conversion materials in the display layer 11 and the light-shielding pattern layer 12 and a decolorization reaction between the electron-donating coloring matter and the electron-accepting material, decolors the image on the display layer 11 and the light-shielding pattern on the light-shielding pattern layer 12, and deletes records. When all records formed on the display layer 11 and the light-shielding pattern layer 12 are deleted at once, the image display element 10 is heated at a temperature that is about the same as that at which the color disappears, for example, 120° C. This deletes the image recorded on the display layer 11 and the light-shielding pattern recorded on the light-shielding pattern layer 12 at once. After that, by performing the operations described above, repeated recording to the display layer 11 and the light-shielding pattern layer 12 is possible.

It should be noted that the color-developed state and the decolorized state are maintained as long as a color developing reaction and a decolorizing reaction such as irradiation with near-infrared ray, heating, or the like described above are not performed.

[Operations and Effects]

As described above, in the image display element 10 according to the first embodiment, the first image 111 and the second image 112 are divided into discrete image elements 111A and image elements 112A, respectively, corresponding to the arrangement pattern of the light-transmitting parts 12TR. This changes the image visible through the light-shielding pattern layer 12 depending on the angle from which the display surface S1 (that is, the light-shielding pattern layer 12) is viewed. Specifically, when the display surface S1 is viewed from the vertical direction, image elements 111A (that is, a first image 111) can be seen through light-transmitting parts 12TR (see the point of sight 2 in FIG. 2). When the display surface S1 is viewed from the oblique direction with a specified angle ±θ, image elements 112A (that is, a second image 112) can be seen through light-transmitting parts 12TR (see the points of sight 1 and 3 in FIG. 2). Accordingly, counterfeiting the image display element 10 is made difficult, and the authenticity of the image display element 10 can be easily judged.

The display layer 11 and the light-shielding pattern layer 12 can be formed by irradiating the first recording layer 11A and the second recording layer 12A with the laser beam L1 and the laser beam L2, respectively. Therefore, since there is no need to produce plates as with holograms, costs can be kept low even when only small quantities of the image display elements 10 are produced. Furthermore, the image display element 10 can be manufactured at a low cost because no lenticular lens is used. Although the concavo-convex cycle of a lenticular lens is, for example, about 100 lines/inch, a stripe pattern can be drawn at 350 lines/inch, for example, in the method for manufacturing the image display element 10 according to the first embodiment. Accordingly, the fineness of a displayed image can be increased, for example, two times or more.

In a display element, in which a lenticular lens is formed on a displayed image part, or a parallax barrier variable display element, the display surface has fine irregularities of the lenticular lens and a printed ink. Therefore, when another layer such as a protective film is laminated on the surface of such devices, small air bubbles are likely to enter the interface therebetween, and air bubbles may remain at the interface after the lamination. If a document or card provided with an image display element in which air bubbles remain at the interface is placed under reduced pressure, such as in an aircraft, the volume of the air bubbles may expand, causing the air bubbles to become more noticeable or the protective film to peel off.

In contrast, in the image display element 10 of the first embodiment, the light-shielding pattern layer 12 is formed by irradiating the second recording layer 12A with a flat surface with the laser beam L2. Therefore, a light-shielding pattern layer 12 with a flat surface can be formed. Accordingly, when another layer such as a protective film is laminated on the display surface S1 of the image display element 10, air bubbles are less likely to enter the interface between the image display element 10 and the other layer mentioned above. Therefore, air bubbles can be prevented from remaining at the interface after lamination.

Display elements, in which a lenticular lens is formed on a display image part, need precise alignment of the concavo-convex cycle of the lenticular lens and the printed image. Furthermore, parallax barrier variable display elements also need precise alignment and superposition of multiple printed matters.

In contrast, since the display layer 11 and the light-shielding pattern layer 12 can be formed by irradiating the first recording layer 11A and the second recording layer 12A with the laser beam L1 and the laser beam L2, respectively, in the image display element 10 according to the first embodiment, precise alignment as the display element described above is not necessary when the display layer 11 and the light-shielding pattern layer 12 are formed.

### 2 SECOND EMBODIMENT

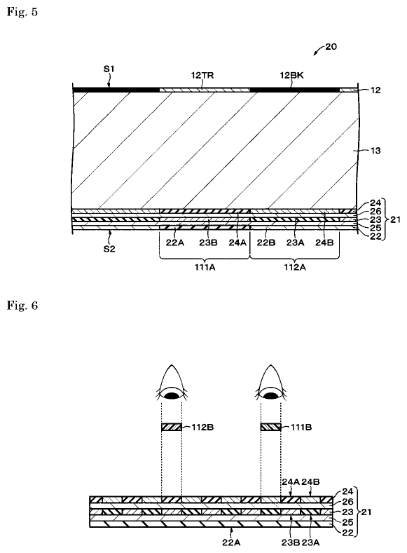

FIG. 5 is a cross-sectional view illustrating an example of a constitution of the image display element 20 according to the second embodiment of the present disclosure. The image display element 20 differs from the image display element 10 according to the first embodiment in that a display layer 21 that displays multicolored (for example, full-colored) first image 111 and second image 112 is provided instead of the display layer 11 (see FIGS. 1 and 2) that displays the single-colored first image 111 and second image 112.

The display layer 21 includes a first layer 22, a second layer 23, a third layer 24, a heat insulation layer 25, and a heat insulation layer 26. The second layer 23 is disposed on the first layer 22, and the third layer 24 is disposed on the second layer 23. The heat insulation layer 25 is disposed between the first layer 22 and the second layer 23, and the heat insulation layer 26 is disposed between the second layer 23 and the third layer 24.

The first layer 22, the second layer 23, and the third layer 24 contain coloring matters that develop mutually different colors, and the coloring matters in each layer form the first image 111 and the second image 112. For example, the first layer 22 contains a coloring matter that develops yellow. For example, the second layer 23 contains a coloring matter that develops cyan. For example, the third layer 23 contains a coloring matter that develops magenta.

For example, the first layer 22 includes a color-developed part 22A containing a coloring matter in the color-developed state and a color-undeveloped part 22B containing a coloring matter in the decolorized state. For example, the second layer 23 includes a color-developed part 23A containing a coloring matter in the color-developed state and a color-undeveloped part 23B containing a coloring matter in the decolorized state. For example, the third layer 24 includes a color-developed part 24A containing a coloring matter in the color-developed state and a color-undeveloped part 24B containing a coloring matter in the decolorized state. The color-undeveloped part 22B, the color-undeveloped part 23B, and the color-undeveloped part 24B have transparency.

It is preferred that the first layer 22, the second layer 23, and the third layer 24 are each composed of a material that enables stable recording and control of the color-developed state. Specifically, the first layer 22, the second layer 23, and the third layer 24 contain electron-donating coloring matters that develop mutually different colors and electron-accepting materials corresponding to respective electron-donating coloring matter, for example. The first layer 22, the second layer 23, and the third layer 24 preferably contain a photothermal conversion material that absorbs light of mutually different wavelength regions and generates heat or a polymer resin, and more preferably contains both these materials.

For example, an electron-accepting material develops colors of a colorless electron-donating coloring matter, or reduces the color of an electron-donating coloring matter developing a prescribed color, as described above. Examples of electron-accepting materials include compounds having a salicylic acid skeleton represented by the formula (2) described above and containing a group with an electron-accepting ability in a molecule. Specifically, a photothermal conversion material is selected from, for example, compounds having a phthalocyanine skeleton (phthalocyanine dyes), compounds having a squarylium skeleton (squarylium dyes), inorganic compounds, and the like, as described above. In addition, as with the first embodiment described above, a compound having a cyanine skeleton (cyanine dye) with excellent light and heat resistance may be used.

Specifically, the first layer 22 contains, for example, an electron-donating coloring matter that develops yellow in the color-developed state, an electron-accepting material corresponding to this, a photothermal conversion material that absorbs infrared rays of a wavelength λ₁ and generates heat, and a polymer resin. The second layer 23 contains, for example, an electron-donating coloring matter that develops cyan in the color-developed state, an electron-accepting material corresponding to this, a photothermal conversion material that absorbs infrared rays of a wavelength λ₂ and generates heat, and a polymer resin. The third layer 24 contains, for example, an electron-donating coloring matter that develops magenta in the color-developed state, an electron-accepting material corresponding to this, a photothermal conversion material that absorbs infrared rays of a wavelength λ₃ and generates heat, and a polymer resin. A display layer 21 capable of multicolor displaying is obtained in this way.

It should be noted that selecting a combination of materials with narrow optical absorption bands that do not overlap each other in the wavelength range of 700 nm or more and 2000 nm or less as the photothermal conversion material is preferable. This enables the color of the desired layer among the first layer 22, the second layer 23, and the third layer 24 to be selectively developed or reduced.

The thicknesses of the first layer 22, the second layer 23, and the third layer 24 are each, for example, 1 μm or more and 20 μm or less, more preferably, for example, 2 μm or more and 15 μm or less. When the thickness of each layer 22, 23, or 24 is less than 1 μm, sufficient color density may not be obtained. When the thickness of each layer 22, 23, or 24 exceeds 20 μm, the amount of heat utilization in each layer 22, 23, or 24 increases, which may degrade the coloring properties.

The first layer 22, the second layer 23, and the third layer 24 may contain various additives such as sensitizers and UV absorbers, in addition to the material described above, as with the display layer 11 described above.

The heat insulation layer 25 insulates the space between the first layer 22 and the second layer 23. The heat insulation layer 26 insulates the space between the second layer 23 and the third layer 24. The heat insulation layer 25 and the heat insulation layer 26 are transparent. Specifically, for example, the heat insulation layer 25 and the heat insulation layer 26 are transparent in the near-infrared and visible regions.

For example, the heat insulation layer 25 and the heat insulation layer 26 contain a common light-transmitting polymer material. Specific examples of the heat insulation layer 25 and heat insulation layer 26 include at least one selected from the group consisting of polyvinyl chloride, polyvinyl acetate, vinyl chloride-vinyl acetate copolymers, ethyl cellulose, polystyrene, styrene copolymers, phenoxy resins, polyester, aromatic polyesters, polyurethane, polycarbonate, polyacrylic esters, polymethacrylate, acrylate copolymers, maleate copolymers, polyvinyl alcohol, modified polyvinyl alcohols, hydroxyethyl cellulose, carboxymethyl cellulose, starch, and the like. The heat insulation layer 25 and the heat insulation layer 26 may contain various additives such as UV absorbers, for example.

The heat insulation layer 25 and the heat insulation layer 26 may contain a light-transmitting inorganic material. For example, the heat insulation layer 25 and the heat insulation layer 26 containing porous silica, alumina, titania, carbon, a complex of these, or the like are preferable because the thermal conductivity is low, and the heat insulation effect is high. For example, the heat insulation layer 25 and the heat insulation layer 26 may be formed by a sol-gel method.

The thicknesses of the heat insulation layer 25 and the heat insulation layer 26 are preferably 3 μm or more and 100 μm or less, more preferably, for example, 5 μm or more and 50 μm or less. If the thicknesses of the heat insulation layer 25 and the heat insulation layer 26 are too thin, sufficient insulation effect cannot be achieved, and if the thicknesses are too thick, the thermal conductivity may deteriorate, or the light-transmitting performance may decrease when the entire display layer 21 is evenly heated.

FIG. 6 is a cross-sectional view for describing the principle of the multicolor displaying of the display layer 21. Here, the principle of multicolor displaying will be explained using the case in which the first layer 22, the second layer 23, and the third layer 24 contain a coloring matter that develops yellow, a coloring matter that develops cyan, and a coloring matter that develops magenta, respectively, as an example.

The part where the color-developed part 22A that developed yellow, the color-developed part 23A that developed cyan, and the color-undeveloped part 24B are overlapped in the thickness direction of the display layer 21 forms a color-developed part 111B that developed green on the first image 111. The part where the color-developed part 22A that developed yellow, the color-undeveloped part 23B, and the color-developed part 23A that developed magenta are overlapped in the thickness direction of the display layer 21 forms a color-developed part 112B that developed red on the first image 111.

Alternatively, the image display element 20 may include a light-shielding pattern layer having the same constitution as the display layer 21 described above, instead of the light-shielding pattern layer 12. In this case, the coloring matters in each of the first layer 22, the second layer 23, and the third layer 24 form the light-shielding parts 12BK.

[Method for Manufacturing Image Display Element]

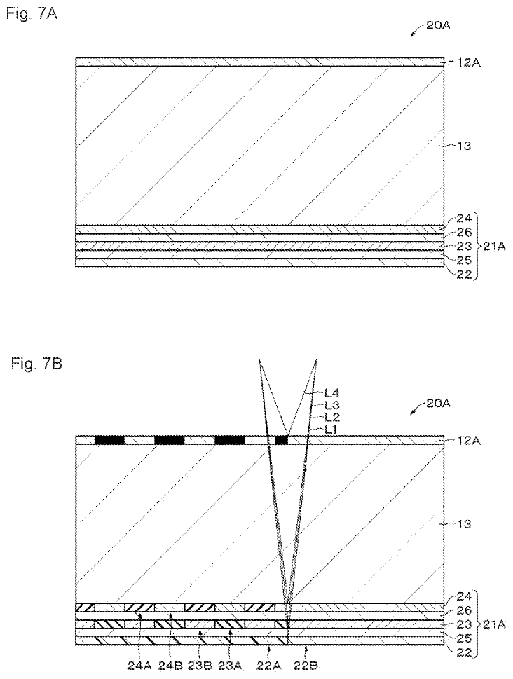

Hereinafter, an example of a method for manufacturing an image display element 20 according to the second embodiment of the present disclosure will be described with reference to FIGS. 7A and 7B.

(Step for Forming Laminate Body)

First, as illustrated in FIG. 7A, a first recording layer 21A and a second recording layer 12A are formed on a first principal surface and a second principal surface of a transparent layer 13, respectively to obtain a laminate body 20A. At this time, a first recording layer 21A is formed by stacking a third layer 24, a heat insulation layer 26, a second layer 23, a heat insulation layer 25, and a first layer 22 in this order on the first principal surface of the transparent layer 13.

(Drawing Step of Image and Light-Shielding Parts)

Next, the desired positions of the first layer 22, the second layer 23, the third layer 24, and the second recording layer 12A are respectively irradiated with a near-infrared laser beams L1 to L4 with adjusted wavelengths and outputs, as illustrated in FIG. 7B, by, for example, a semiconductor laser or the like. This causes the generation of heat from photothermal conversion materials in the first layer 22, the second layer 23, the third layer 24, and the second recording layer 12A and coloring reaction (color developing reaction) between the electron-donating coloring matter and the electron-accepting material, resulting in the development of color in the irradiated area. In this way, a color-developed part 22A and a color-undeveloped part 22B are formed on the first layer 22, a color-developed part 23A and a color-undeveloped part 23B are formed on the second layer 23, and a color-developed part 24A and a color-undeveloped part 24B are formed on the third layer 24. Accordingly, a display layer 21 that displays the first image 111 and the second image 112 is obtained. Furthermore, light-shielding parts 12BK and the light-transmitting parts 12TR are formed on the second recording layer 12A, and a light-shielding pattern layer 12 is obtained.

As illustrated in FIG. 7B, it is preferred to irradiate the first layer 22, the second layer 23, the third layer 24, and the second recording layer 12A with the laser beams L1 to L4, respectively, while aligning the optical axes of the laser beams L1 to L4. By controlling the irradiation with the laser beams L1 to L4 in this way, it is no longer necessary to align the optical axes of the laser beams L1 to L4, respectively, when drawing the first layer 22, the second layer 23, the third layer 24, and the second recording layer 12A. Furthermore, the misalignment of the light-shielding parts 12BK, the light-transmitting parts 12TR, the image elements 111A, and the image elements 112A can be suppressed. Since the heat insulation layer 25 and the heat insulation layer 26 are thin, the focal points of the laser beams L1 to L3 may be substantially coincident. In addition, since the transparent layer 13 is thin, the focal points of the laser beams L3 and L4 may be substantially coincident.

[Operations and Effects]

As described above, the image display element 20 according to the second embodiment includes the first layer 22, the second layer 23, and the third layer 24. The first layer 22, the second layer 23, and the third layer 24 contain coloring matters that develop mutually different colors, and the coloring matters in each layer form the first image 111 and the second image 112. This enables displaying a multicolored (for example, full-colored) first image 111 and a multicolored (for example, full-colored) second image 112. In addition, the first image 111 and the second image 112 with mutually different hues can be displayed. For example, a red first image 111 and a green second image 112 can be displayed.

### 3 THIRD EMBODIMENT

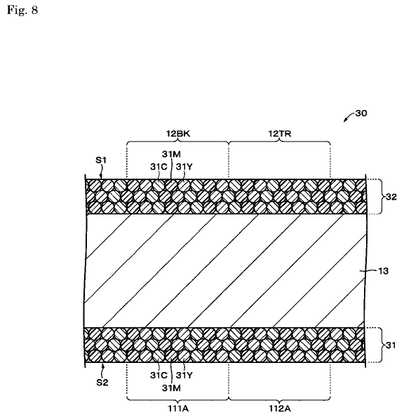

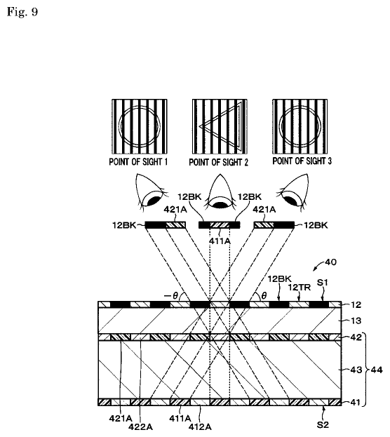

FIG. 8 is a cross-sectional view illustrating an example of the constitution of the image display element 30 according to the third embodiment of the present disclosure. The image display element 30 differs from the image display element 20 according to the second embodiment in that a single-layer structure display layer 31 that displays multicolored (for example, full-colored) first image 111 and second image 112 is provided instead of the three-layer structure display layer 21 (see FIG. 5) that displays multicolored (for example, full-colored) first image 111 and second image 112.

The display layer 31 contains three types of microcapsules 31C, 31M, and 31Y, which develop mutually different colors in the color-developed state, and a polymer resin. These three types of microcapsules 31C, 31M, and 31Y form the first image 111 and the second image 112. The microcapsules 31C, 31M, and 31Y each include, for example, an electron-donating coloring matter that develops mutually different colors (for example, cyan (C), magenta (M), and yellow (Y)), an electron-accepting material corresponding to respective electron-donating coloring matters, a photothermal conversion material that absorbs light of mutually different wavelength regions and generates heat, and a capsule wall. The electron-donating coloring matter, electron-accepting material, and photothermal conversion material are housed in the capsule wall. For example, a material constituting the heat insulation layer 25 and heat insulation layer 26 described above is preferably used as the material for the capsule wall.

As illustrated in FIG. 8, the image display element 30 may include a light-shielding pattern layer 32 having the same constitution as the display layer 31 instead of the light-shielding pattern layer 12 in the first embodiment. That is, the light-shielding pattern layer 32 containing three types of microcapsules 31C, 31M, and 31Y and a polymer resin may be included. In this case, these three types of microcapsules 31C, 31M, and 31Y form the light-shielding parts 12BK.

[Operations and Effects]

As described above, in the image display element 30 according to the third embodiment, the display layer 31 contains three types of microcapsules 31C, 31M, and 31Y, which develop mutually different colors in the color-developed state, and a polymer resin. These three types of microcapsules 31C, 31M, and 31Y (specifically, coloring matters in each of these three types of microcapsules 31C, 31M, and 31Y) form the first image 111 and the second image 112. This enables displaying a multicolored (for example, full-colored) first image 111 and a multicolored (for example, full-colored) second image 112 on a single-layer structure display layer 31. In addition, the first image 111 and the second image 112 with mutually different hues can be displayed on a single-layer structure display layer 31. For example, a red first image 111 and a green second image 112 can be displayed on a single-layer structure display layer 31.

### 4 FOURTH EMBODIMENT

[Configuration of Image Display Element]

FIG. 9 is a cross-sectional view illustrating an example of the constitution of an image display element 40 according to the fourth embodiment of the present disclosure. The image display element 40 differs from the image display element 10 according to the first embodiment in that a display layer 44 is provided instead of the display layer 11 (see FIGS. 1 and 2). The display layer 44 includes a first display layer 41, a second display layer 42, and a transparent layer 43. The second display layer 42 is disposed opposite to the first display layer 41. The transparent layer 43 is disposed between the first display layer 41 and the second display layer 42. In the image display element 40 according to the fourth embodiment, the transparent layer 13 is an example of the first transparent layer, and the transparent layer 43 is an example of the second transparent layer.

(First Display Layer, Second Display Layer)

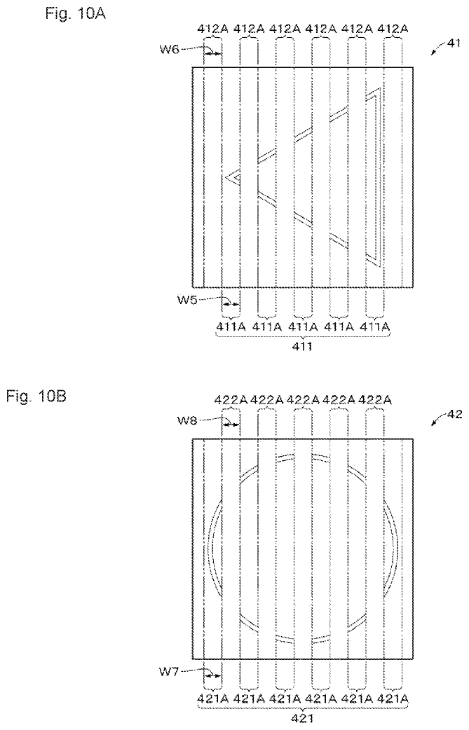

FIG. 10A is a plan view illustrating an example of a constitution of the first display layer 41. The first display layer 41 displays a first image 411. The first image 411 is divided into discrete image elements 411A corresponding to the arrangement pattern of the light-transmitting parts 12TR. Separation parts 412A are formed between the image elements 411A that are divided discretely. That is, the image elements 411A and the separation parts 412A are alternately arranged in the in-plane direction of the first display layer 41.

The first display layer 41 contains a coloring matter, and this coloring matter forms the first image 411. The separation parts 412A may have transparency and may develop color. The first display layer 41 is the same as the display layer 11 in the first embodiment, the display layer 21 in the second embodiment, and the display layer 31 in the third embodiment, except for the matters mentioned above.

FIG. 10B is a plan view illustrating an example of a constitution of the second display layer 42. The second display layer 42 displays the second image 421. The second image 421 is divided into discrete image elements 421A corresponding to the arrangement pattern of the light-transmitting parts 12TR. Separation parts 422A are formed between the image elements 421A that are divided discretely. That is, the image elements 421A and the separation parts 422A are alternately arranged in the in-plane direction of the second display layer 42.

The second display layer 42 contains a coloring matter, and this coloring matter forms the second image 421. The coloring matter in the separation parts 422A is in a decolorized state, and the separation parts 422A have transparency. The second display layer 42 is the same as the display layer 11 in the first embodiment, the display layer 21 in the second embodiment, and the display layer 31 in the third embodiment, except for the matters mentioned above.

The image elements 411A, the separation parts 422A, and the light-transmitting parts TR overlap in the thickness direction of the image display element 40. The separation parts 412A, the image elements 421A, and the light-shielding parts BK overlap in the thickness direction of the image display element 40. The image elements 411A have substantially the same width as the light-transmitting parts 12TR. The term “substantially the same width” herein means that the ratio (W2:W5) between the width W2 of a light-transmitting part 12TR and the width W5 of an image element 411A is within the range of 1:0.9 to 1:1.1. The separation parts 412A have substantially the same width as the light-transmitting parts 12TR. The term “substantially the same width” herein means that the ratio (W2:W6) between the width W2 of a light-transmitting part 12TR and the width W6 of a separation part 412A is within the range of 1:0.9 to 1:1.1. The image elements 421A have substantially the same width as the light-transmitting parts 12TR. The term “substantially the same width” herein means that the ratio (W2:W7) between the width W2 of a light-transmitting part 12TR and the width W7 of an image element 421A is within the range of 1:0.9 to 1:1.1. The separation parts 422A have substantially the same width as the light-transmitting parts 12TR. The term “substantially the same width” herein means that the ratio (W2:W8) between the width W2 of a light-transmitting part 12TR and the width W8 of a separation part 422A is within the range of 1:0.9 to 1:1.1.

(Transparent Layer)

The transparent layer 43 is for separating the space between the first display layer 41 and the second display layer 42. For example, the transparent layer 43 is a transparent film. The thickness of the transparent layer 43 is, for example, 50 μm or more and 600 μm or less. The transparent layer 43 is constituted such that the light that has passed through the separation parts 422A and the light that has been reflected on the first display layer 41 or the like are allowed to pass through. As a material of the transparent layer 43, the same type as the transparent layer 13 can be exemplified.

[Method for Manufacturing Image Display Element]

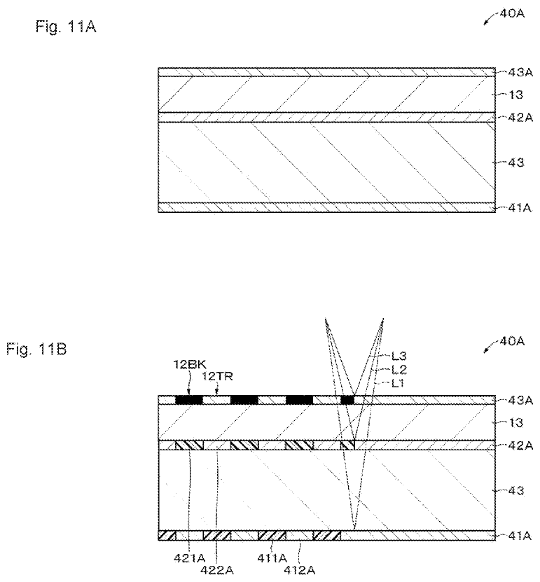

Hereinafter, an example of a method for manufacturing an image display element 40 according to the fourth embodiment of the present disclosure will be described with reference to FIGS. 11A and 11B.

(Step of Forming Laminate Body)

A laminate body 10A illustrated in FIG. 11A is formed in the following way. First, a first recording layer 41A and a second recording layer 42A are formed on a first principal surface and a second principal surface of a transparent layer 43, respectively. Subsequently, a transparent layer 13 and a third recording layer 43A are formed on the second recording layer 42A. A laminate body 40A is formed in this way.

(Drawing Step of Image and Light-Shielding Parts)

The desired positions of the first, second, and third recording layers 41A, 42A, and 43A are respectively irradiated with near-infrared laser beams L1, L2, and L3 with adjusted wavelengths and outputs as illustrated in FIG. 11B by, for example, a semiconductor laser or the like. This causes the generation of heat from photothermal conversion materials in the first, second, and third recording layers 41A, 42A, 43A, and coloring reaction (color developing reaction) between the electron-donating coloring matter and the electron-accepting material, resulting in the development of color in the irradiated area. A first image 411 is formed on the first recording layer 41A in this way, and a first display layer 41 is obtained. A second image 422 is formed on the second recording layer 42A, and a second display layer 42 is obtained. Furthermore, light-shielding parts 12BK and the light-transmitting parts 12TR are formed on the third recording layer 43A, and a light-shielding pattern layer 12 is obtained.

As illustrated in FIG. 11B, it is preferred to irradiate the first, second, and third recording layers 41A, 42A, and 43A with the near-infrared laser beams L1, L2, and L3, respectively, while aligning the optical axes of the near-infrared laser beams L1, L2, and L3. Since a transparent layer 43 is thin, the focal points of the laser beam L1 and the laser beam L2 may be substantially coincident. In addition, since the transparent layer 13 is thin, the focal points of the laser beam L2 and the laser beam L3 may be substantially coincident.

[Operations and Effects]

As described above, in the image display element 40 according to the fourth embodiment, the display layer 44 includes a first display layer 41 that displays the first image 411, the second display layer 42 that is disposed opposite to the first display layer 41 and displays the second image 422, and a transparent layer 43 disposed between the first display layer 41 and the second display layer 42. Each of the first image 411 and the second image 422 is divided discretely, corresponding to the arrangement pattern of the light-transmitting parts 12TR. This changes the image visible through the light-shielding pattern layer 12 depending on the angle from which the display surface S1 (that is, the light-shielding pattern layer 12) is viewed. Specifically, when the display surface S1 is viewed from the vertical direction, image elements 411A (that is, a first image 411) can be seen from light-transmitting parts 12TR through the separation parts 422A (see the point of sight 2 in FIG. 9). When the display surface S1 is viewed from the oblique direction with a specified angle ±θ, image elements 421A (that is, a second image 421) can be seen through light-transmitting parts 12TR (see the points of sight 1 and 3 in FIG. 9).

### 5 FIFTH EMBODIMENT

[Configuration of Image Display Element]

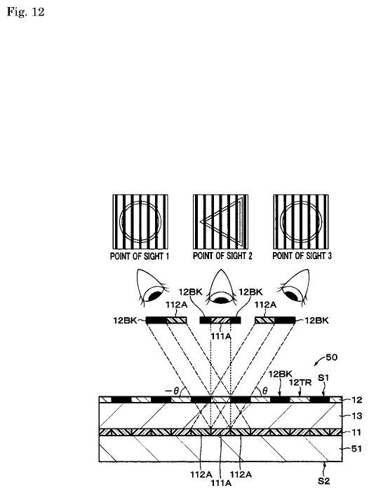

FIG. 12 is a cross-sectional view illustrating an example of the constitution of an image display element 50 according to the fifth embodiment of the present disclosure. The image display element 50 differs from the image display element 10 according to the first embodiment in that the image display element 50 further includes a back surface layer 51 disposed on the display layer 11.

For example, the back surface layer 51 is a background layer, a reflective layer, or a laminate body of these layers. The background layer is for adding and displaying a background to the first image 111 and the second image 112. Examples of the background layer include patterns, pictures, characters, combinations of two or more of them, and the like. The reflective layer is for reflecting light that has passed through the display layer 11. Examples of the reflective layer include metal reflective layers, white reflective layers, and the like.

[Operations and Effects]

The image display element 50 according to the fifth embodiment of the present disclosure can add and display a background to the first image 111 and the second image 112 when the back surface layer 51 is a background layer. Meanwhile, when the back surface layer 51 is a reflective layer, the first image 111 and the second image 112 can be brightened. Accordingly, displaying clearer images is possible.

### 6 SIXTH EMBODIMENT

[Configuration of Image Display Element]

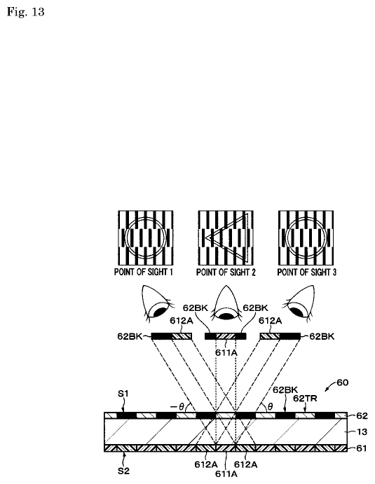

FIG. 13 is a cross-sectional view illustrating an example of the constitution of the image display element 60 according to the sixth embodiment of the present disclosure. The image display element 60 differs from the image display element 10 according to the first embodiment in that a display layer 61 and a light-shielding pattern layer 62 are provided instead of the display layer 11 and the light-shielding pattern layer 12 (see FIGS. 1 and 2).

(Light-Shielding Pattern Layer)

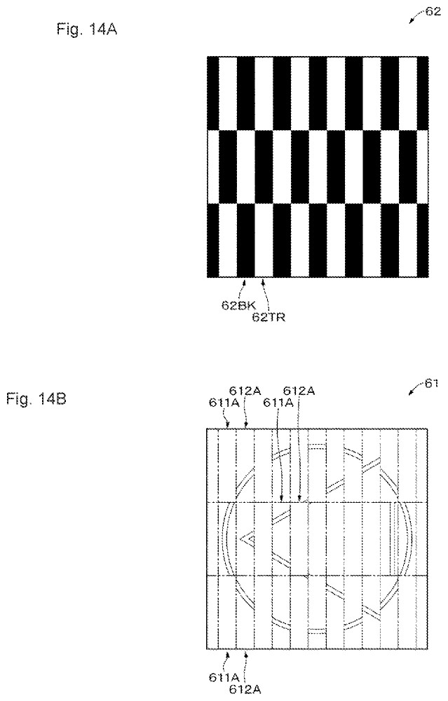

FIG. 14A is a plan view illustrating an example of the constitution of the light-shielding pattern layer 62. The light-shielding pattern layer 62 has rectangular-shaped light-shielding parts 62BK and light-transmitting parts 62TR, and these light-shielding parts 62BK and light-transmitting parts 62TR are arranged in a checkerboard arrangement pattern. In detail, the light-shielding pattern layer 62 has light-shielding parts 62BK and light-transmitting parts 62TR arranged alternately in a plurality of rows. The light-shielding parts 62BK and the light-transmitting parts 62TR in adjacent rows are arranged side by side. However, the light-shielding parts 62BK and the light-transmitting parts 62TR in adjacent rows may be arranged shiftedly.

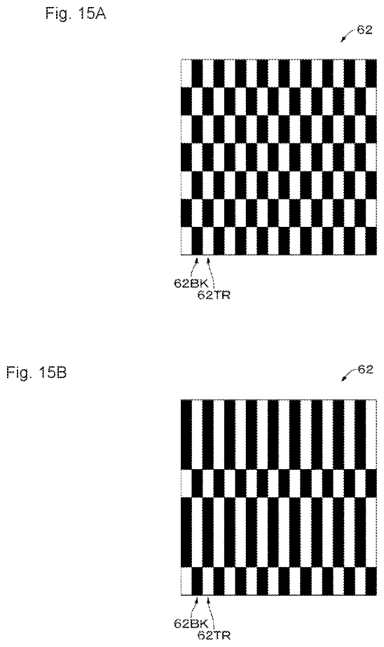

It should be noted that FIG. 14A shows an example wherein the number of rows in which the light-shielding parts 62BK and the light-transmitting parts 62TR are alternately arranged is three is illustrated, but the number of the rows is not limited thereto, and the number of rows may be 4 or more, as illustrated in FIG. 15A, or may be two.

Furthermore, FIG. 14A shows an example wherein the widths of adjacent rows are identical, but the widths of adjacent rows may vary, as illustrated in FIG. 15B.

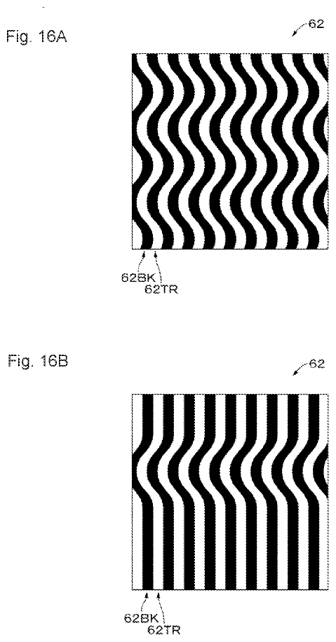

Furthermore, the shapes of the light-shielding parts 62BK and the light-transmitting parts 62TR is not limited to rectangular shapes, and may be wavy, as illustrated in FIGS. 16A and 16B.

(Display Layer)

FIG. 14B is a plan view illustrating an example of the constitution of a display layer 61. The display layer 61 has a first image and a second image. The first image and the second image are divided into discrete image elements 611A and image elements 612A, respectively, corresponding to the arrangement pattern of the light-transmitting parts 62TR. The image element 611A and image element 612A have rectangular shapes with the substantially same size as the light-transmitting parts 62TR.

The arrangement pattern of the image elements 611A and the image elements 612B are each the same as the arrangement pattern (that is, a checkerboard arrangement pattern) of the light-transmitting parts 62TR of the light-shielding pattern layer 62. That is, the display layer 61 has a plurality of rows in which the image elements 611A and the image elements 612A are alternately arranged. The image element 611A and the image element 612A in adjacent rows are arranged side by side. However, the image elements 611A and the image elements 612A in adjacent rows may be arranged shiftedly.

[Operations and Effects]

As described above, in the image display element 60 according to the sixth embodiment, the light-shielding parts 62BK and the light-transmitting parts 62TR of the light-shielding pattern layer 62 are arranged in a checkerboard arrangement pattern. Furthermore, the first image and the second image of the display layer 61 are divided into discrete image elements 611A and image elements 612A, respectively, corresponding to the arrangement pattern of the light-transmitting parts 62TR. Therefore, the image display element 60 can make the counterfeiting more difficult than the image display element 10 according to the first embodiment.

### 7 SEVENTH EMBODIMENT

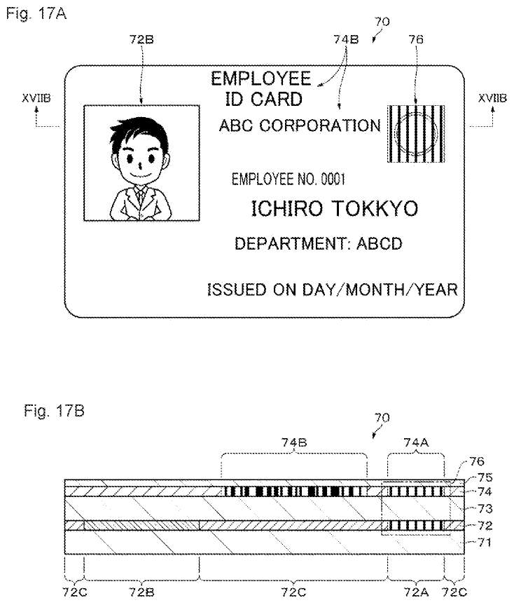

FIG. 17A is a plan view illustrating an example of the constitution of the card 70 according to the seventh embodiment of the present disclosure. FIG. 17B is a cross-sectional view along the line XVIIB-XVIIB in FIG. 17A. The card 70 includes a supporting base 71, a first recording layer 72 disposed on the supporting base 71, a transparent layer 73 disposed on the first recording layer 72, a second recording layer 74 disposed on the transparent layer 73, and a protective layer 75 disposed on the second recording layer 74.

The card 70 is an example of a drawing body, specifically an identification card such as, for example, an employee or student ID card. FIGS. 17A and 17B illustrate an example in which the card 70 is an employee ID card. However, the card 70 is not limited to identification cards such as employee or student ID cards, and may be credit cards, certificates of qualification (for example, driver's licenses), insurance cards, medical cards, membership cards, or the like. Furthermore, the drawing body is not limited to cards, and may be documents such as passports.

(Supporting Base)

The supporting base 71 is for supporting each layer of the first recording layer 72, transparent layer 73, second recording layer 74, and protective layer 75. For example, the supporting base 71 contains a polymer resin. The supporting base may or may not have transparency.

(First Recording Layer)

For example, the first recording layer 72 contains the same material as the display layer 11 in the first embodiment. The first recording layer 72 includes a display part 72A, a photograph 72B, and a background part 72C. The display part 72A, the photograph 72B, and the background part 72C are arranged in the in-plane direction of the supporting base 71. The display part 72A has the same constitution as the display layer 11 in the first embodiment. That is, the display part 72A displays the first image 111 and the second image 112 (see FIG. 3). The photograph 72B is formed by a coloring matter in the first recording layer 72. Specifically, the photograph 72B is formed by a color-development reaction between the electron-donating coloring matter and the electron-accepting material in the first recording layer 72. The background part 72C forms the background of the card 70. Examples of the background include patterns, pictures, combinations of them, and the like. The background part 72C is formed by a coloring matter in the first recording layer 72. Specifically, the background part 72C is formed by a color-development reaction between the electron-donating coloring matter and the electron-accepting material in the first recording layer 72.

However, the photograph 72B may be formed by interposing a printed matter or the like, which was formed separately, between the supporting base 71 and the transparent layer 73, or may be printed separately on the supporting base 71. Similarly, the background part 72C may be formed by interposing a printed matter or the like, which was formed separately, between the supporting base 71 and the transparent layer 73, or may be printed separately on the supporting base 71.

The display part 72A, the photograph 72B, and the background part 72C have flat surfaces. As described later, the display part 72A, the photograph 72B, and the background part 72C have flat surfaces because the display part 72A, the photograph 72B, and the background part 72C are formed by irradiating an unrecorded first recording layer 72 with a laser beam.

(Second Recording Layer)

The second recording layer 74 is disposed opposite to the first recording layer 72. For example, the second recording layer 74 contains the same material as the light-shielding pattern layer 12 in the first embodiment. The second recording layer 74 includes a light-shielding pattern part 74A and a character drawing area 74B. The light-shielding pattern part 74A is disposed opposite to the display part 72A. The light-shielding pattern part 74A has the same constitution as the light-shielding pattern layer 12 in the first embodiment. That is, the light-shielding pattern part 74A has alternately disposed light-shielding parts 12BK and light-transmitting parts 12TR (see FIGS. 1 and 2). The characters in the character drawing area 74B are formed by a coloring matter in the second recording layer 74. Specifically, the characters in the character drawing area 74B are formed by a color-development reaction between the electron-donating coloring matter and the electron-accepting material in the second recording layer 74. However, the characters in the character drawing area 74B may be formed on the transparent layer 73 by the printing or the like.

The light-shielding pattern part 74A and the character drawing area 74B have flat surfaces. As described later, the light-shielding pattern part 74A and the character drawing area 74B have flat surfaces because the light-shielding pattern part 74A and the character drawing area 74B are formed by irradiating an unrecorded second recording layer 74 with a laser beam.

(Transparent Layer)

A transparent layer 73 is disposed between the first recording layer 72 and the second recording layer 74. The transparent layer 73 is the same as the transparent layer 13 in the first embodiment.

(Protective Layer)

The protective layer 75 protects the surface of the second recording layer 74. For example, the protective layer 75 is a transparent film or coating layer.

(Image Display Element)

The image display element 76 is constituted of the display part 72A, a light-shielding pattern part 74A disposed opposite to the display part 72A, and a transparent layer 73 between the display part 72A and the light-shielding pattern part 74A.

[Method for Manufacturing Image Display Element]

Hereinafter, an example of a method for manufacturing a card 70 according to the seventh embodiment of the present disclosure will be described.

(Lamination Step)

First, a coating material for forming recording layers is coated on the supporting base 71 and dried at, for example, 70° C. An unrecorded first recording layer 72 is formed in this way. Next, a transparent layer 73 is formed by laminating a film on the first recording layer 72 or coating a resin on the first recording layer 72 and curing the resin. Next, a coating material for forming recording layers is coated on a transparent layer 73 and dried at, for example, 70° C. An unrecorded second recording layer 74 is formed in this way. An unrecorded card 70 is obtained in this way.

The first recording layer 72 and the second recording layer 74 may be formed using a method other than the coating described above. For example, the first recording layer 72 and the second recording layer 74 may be formed in advance on separate substrates, respectively, and laminated on the supporting base 71 and the transparent layer 73, respectively, via adhesive layers.

(Drawing Step)

Next, in the same manner as the method for manufacturing the image display element 10 according to the first embodiment (see FIG. 4B), the desired positions of the first recording layer 72 and the second recording layer 74 are respectively irradiated with a near-infrared laser beam L1 and a near-infrared laser beam L2 with adjusted wavelengths and outputs by, for example, a semiconductor laser or the like. This causes the generation of heat from photothermal conversion materials in the first recording layer 72 and the second recording layer 74 and coloring reaction (color developing reaction) between the electron-donating coloring matter and the electron-accepting material, resulting in the development of color in the irradiated area. The display part 72A, the photograph 72B, and the background part 72C are formed on the first recording layer 72 is formed in this way. Furthermore, the light-shielding pattern part 74A and the character drawing area 74B are formed on the second recording layer 74. In FIG. 17B, the photograph 72B and the background part 72C are formed on the first recording layer 72, and the character drawing area 74B is formed on the second recording layer 74. Meanwhile, it is not necessary to regulate the layer on which the photograph 72B, the character drawing area 74B, and the background part 72C are formed, and they each may be formed on the first recording layer 72, or may be formed on the second recording layer 74. That is, the first recording layer 72 may include at least one of the photograph 72B, the character drawing area 74B, and the background part 72C (pattern or the like) formed by a coloring matter, or the second recording layer 74 may include at least one of the photograph 72B, the character drawing area 74B, and the background part 72C (pattern or the like) formed by a coloring matter.

The display part 72A, the photograph 72B, and the background part 72C formed on the first recording layer 72, and the light-shielding pattern part 74A and character drawing area 74B formed on the second recording layer 74 can be rewritten.

(Step of Forming Protective Layer)

Next, a protective layer 75 is formed by laminating a transparent film on the second recording layer 74 via an adhesive layer or coating a resin on the second recording layer 74 and curing the resin. The protective layer 75 may be formed prior to the drawing step. In that case, irradiation with a laser beam for drawing on the first recording layer 72 and the second recording layer 74 is performed through the protective layer 75.

[Operations and Effects]

As mentioned above, the card 70 is made difficult to counterfeit and the authenticity of the card 70 can be easily judged because the card 70 according to the seventh embodiment includes the image display element 76.

The card 70 includes the first recording layer 72, the second recording layer 74 disposed opposite to the first recording layer 72, and the transparent layer 73 disposed between the first recording layer 72 and the second recording layer 74. This enables forming the display part 72A, the photograph 72B, the background part 72C, the light-shielding pattern part 74A, and the character drawing area 74B by irradiating the first recording layer 72 and the second recording layer 74 with a laser beam L1 and a laser beam L2, respectively. Accordingly, the display part 72A, the photograph 72B, background part 72C, the light-shielding pattern part 74A, and the character drawing area 74B can be formed simultaneously with the formation of the image display element 76. The card 70 can be easily constructed in this way.

The light-shielding pattern part 74A and the character drawing area 74B have flat surfaces because they are formed by irradiating a second recording layer 74 with a flat surface with a laser beam L2. Accordingly, when a film is laminated on the second recording layer 74 to form the protective layer 75, air bubbles can be made difficult to enter the interface between the light-shielding pattern part 74A and character drawing area 74B and the protective layer 75. Accordingly, air bubbles can be prevented from remaining at the interface after lamination.

### 8 EIGHTH EMBODIMENT

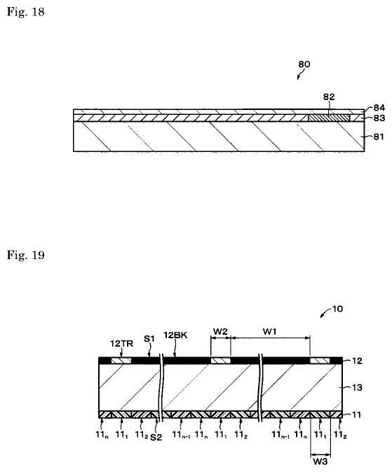

FIG. 18 is a plan view illustrating an example of the constitution of the card 80 according to the eighth embodiment of the present disclosure.

The card 80 includes a supporting base 81, an image display element 82 and an adhesive layer 83 disposed on the supporting base 81, and the protective layer 84 laminated on the supporting base 81 via the adhesive layer 83.

(Supporting Base)

The supporting base 81 is for supporting the image display element 82. For example, the supporting base 81 contains a polymer resin. At least one of characters, photographs, and backgrounds (for example, patterns, pictures, characters, combinations of these, or the like) may be formed on the supporting base 81 by the printing or the like.

(Adhesive Layer)

The adhesive layer 83 is disposed so as to surround the image display element 82 and bonds the supporting base 81 and the protective layer 84. A pressure sensitive adhesion herein is defined as one type of adhesion. According to this definition, a pressure sensitive adhesive layer is considered one type of the adhesive layer 83.

(Image Display Element)

The image display element 82 is any of the image display elements 10 to 60 according to the first to sixth embodiments.

(Protective Layer)

The protective layer 84 is for protecting the image display element 82, printed matters, or the like disposed on the supporting base 81. For example, the protective layer 84 is a transparent film.

[Operations and Effects]

As mentioned above, the card 80 is made difficult to counterfeit and the authenticity of the card 80 can be easily judged because the card 80 according to the eighth embodiment includes the image display element 82.

### 8 MODIFICATION EXAMPLES

### Modification Example 1

Although an example wherein the display layer 11 displays the first image 111 and the second image 112 in the first embodiment was described, a first to n-th (where n is an integer of 2 or more) images may be displayed, as illustrated in FIG. 19. In this case, the display layer 11 contains a coloring matter, and this coloring matter forms first to n-th images. More specifically, the display layer 11 contains an electron-donating coloring matter and an electron-accepting material, and the first to n-th images are formed by a coloring reaction between the electron-donating coloring matter and the electron-accepting material. The first to n-th images is divided into discrete image elements 11₁ to 11n corresponding to the arrangement pattern of the light-transmitting parts 12TR. The image elements 11₁ to 11n of the first to n-th images are arranged repeatedly in an in-plane direction of the display layer 11 in the order of the image elements 11₁ to 11n of the first to n-th images. The ratio (W1:W2) between the width W1 of a light-shielding part 12BK and the width W2 of a light-transmitting part 12TR is preferably about (n−1):1, specifically (n−1):0.9 to (n−1):1.1. The image elements 11₁ to 11n each have substantially the same width as the light-transmitting parts 12TR. The term “substantially the same width” herein means that the ratio (W2:W3) between the width W2 of a light-transmitting part 12TR and the width W3 of each of the image elements 11₁ to 11n is within the range of 1:0.9 to 1:1.1.

It should be noted that, similarly in the second to sixth embodiments, the display layers 11, 21, 31, 44, and 61 may display a first to n-th (where n is an integer of 2 or more) images. Similarly, in the seventh embodiment, the first recording layer 72 may display a first to n-th (where n is an integer of 2 or more) images.

### Modification Example 2

In the first to sixth embodiments, examples wherein the reactions between the electron-donating coloring matter and the electron-accepting material in the display layers 11, 21, 31, 44, and 61 and the light-shielding pattern layers 12, 32, and 62 are reversible were described, but the reaction between the electron-donating coloring matter and the electron-accepting material may be irreversible. Similarly, the reaction between the electron-donating coloring matter and the electron-accepting material in the first recording layer 72 and the second recording layer 74 in the seventh embodiment may be irreversible. When the reaction is irreversible, as described above, a color developing reagent is used instead of the color developing/reducing reagent as an electron-accepting material. When the reaction is irreversible, as described above, rewriting images becomes difficult, thus increasing the security.

### Modification Example 3

In the first embodiment, an example wherein the display layer 11 and the light-shielding pattern layer 12 both contain coloring matters was described, but at least one the display layer 11 and the light-shielding pattern layer 12 may contain a coloring matter.

When the display layer 11 among the display layer 11 and the light-shielding pattern layer 12 contains a coloring matter, this coloring matter forms the first image 111 and the second image 112.

When the light-shielding pattern layer 12 among the display layer 11 and light-shielding pattern layer 12 contains a coloring matter, this coloring matter forms the light-shielding parts 12BK.

When the display layer 11 among the display layer 11 and the light-shielding pattern layer 12 contains no coloring matter, the first image 111 and the second image 112 may be formed with a printing ink.

When the light-shielding pattern layer 12 among the display layer 11 and the light-shielding pattern layer 12 contains no coloring matter, the light-shielding parts 12BK may be formed with a printing ink containing a pigment such as carbon black, or may be formed with a color resist. The light-transmitting parts 12TR may be formed with a transparent resin, and may be formed with spaces.

It should be noted that, in the second to sixth embodiments, the display layers 11, 21, 31, 44, 61 and the light-shielding pattern layers 12, 32, 62 may have the same constitution as the Modification Example 3 described above. In the seventh embodiment, the first recording layer 72 and the second recording layer 74 may have the same constitution as the Modification Example 3 described above.

### Modification Example 4

In the first embodiment, an example wherein the display layer 11 and the light-shielding pattern layer 12 both contain the electron-donating coloring matter and the electron-accepting material was described, but at least one of the display layer 11 and the light-shielding pattern layer 12 may contain the electron-donating coloring matter and the electron-accepting material. In this case, the layer containing the electron-donating coloring matter and the electron-accepting material preferably contains a photothermal conversion material or a polymer material, and more preferably contains both these materials.

When the display layer 11 among the display layer 11 and the light-shielding pattern layer 12 contains the electron-donating coloring matter and the electron-accepting material, the first image 111 and the second image 112 are formed by the reaction between the electron-donating coloring matter and the electron-accepting material.

When the light-shielding pattern layer 12 among the display layer 11 and light-shielding pattern layer 12 contains the electron-donating coloring matter and the electron-accepting material, the light-shielding parts 12BK is formed by the reaction between the electron-donating coloring matter and the electron-accepting material.

When the display layer 11 among the display layer 11 and the light-shielding pattern layer 12 contains no electron-donating coloring matter and no electron-accepting material, the first image 111 and the second image 112 may be formed with printing ink.

When the light-shielding pattern layer 12 among the display layer 11 and the light-shielding pattern layer 12 contains no electron-donating coloring matter and no electron-accepting material, the light-shielding parts 12BK may be formed with a printing ink containing a pigment such as carbon black, or may be formed with a color resist. The light-transmitting parts 12TR may be formed with a transparent resin, and may be formed with spaces.

It should be noted that in the second to sixth embodiments, the display layers 11, 21, 31, 44, and 61 and the light-shielding pattern layers 12, 32, and 62 may have the same constitutions as the Modification Example 4 described above. In the seventh embodiment, the first recording layer 72 and the second recording layer 74 may have the same constitution as the Modification Example 4 described above.

### Modification Example 5

The constitution of the first recording layer 72 and a second recording layer 74 explained in the seventh embodiment is exemplary, and the constitution of the first recording layer 72 and the second recording layer 74 is not limited to this example. For example, the constitution explained below may be adopted as the constitution of the first recording layer 72 and the second recording layer 74.

In the seventh embodiment, the first recording layer 72 may have the same three-layered constitution as the display layer 21 in the second embodiment. In this case, the coloring matters in each of the first layer 22, the second layer 23, and the third layer 24 form the display part 72A, photograph 72B, and background part 72C. More specifically, they are formed by a color-development reaction between the electron-donating coloring matter and the electron-accepting material in each of the first layer 22, second layer 23, and third layer 24.

In the seventh embodiment, the second recording layer 74 may have the same three-layered constitution as the display layer 21 in the second embodiment. In this case, the coloring matters in each of the first layer 22, the second layer 23, and the third layer 24 form the light-shielding pattern part 74A and the character drawing area 74B. More specifically, they are formed by a color-development reaction between the electron-donating coloring matter and the electron-accepting material in each of the first layer 22, second layer 23, and third layer 24.

In the seventh embodiment, the first recording layer 72 may have the same constitution as the display layer 31 in the third embodiment. In this case, three types of microcapsules 31C, 31M, and 31Y (specifically, coloring matters in each of these three types of microcapsules 31C, 31M, and 31Y) form the display part 72A, the photograph 72B, and the background part 72C.

In the seventh embodiment, the second recording layer 74 may have the same constitution as the display layer 31 in the third embodiment. In this case, three types of microcapsules 31C, 31M, and 31Y (specifically, coloring matters in each of these three types of microcapsules 31C, 31M, and 31Y) form the light-shielding pattern part 74A and character drawing area 74B.

In the seventh embodiment, the first recording layer 72 may have the same constitution as the display layer 44 in the fourth embodiment. In this case, the coloring matters in each of the first display layer 41 and the second display layer 42 form the display part 72A, the photograph 72B, and the background part 72C. More specifically, they are formed by a color-development reaction between the electron-donating coloring matter and the electron-accepting material in each of the first display layer 41 and the second display layer 42.

In the seventh embodiment, the display part 72A may have the constitution as the display layer 61 in the sixth embodiment, and the light-shielding pattern part 74A may have the same constitution as the light-shielding pattern layer 62 in the sixth embodiment.

### Modification Example 6

In the first embodiment described above, an example wherein the display layer 11 and the light-shielding pattern layer 12 contains a single (single-type) electron-donating coloring matter was described, but the constitutions of the display layer 11 and the light-shielding pattern layer 12 are not limited thereto. The display layer 11 and the light-shielding pattern layer 12 may contain multiple types of electron-donating coloring matters that develop mutually different colors. Various colors, including the CMY of Japan color, can be reproduced when the display layer 11 and the light-shielding pattern layer 12 contain multiple types of electron-donating coloring matters. For example, cyan color can be reproduced by mixing an electron-donating coloring matter that develops blue with an electron-donating coloring matter that develops green in a given ratio. Magenta color can be reproduced by mixing an electron-donating coloring matter that develops red with an electron-donating coloring matter that develops orange in a given ratio.

It should be noted that, similarly, in the second and the fourth to sixth embodiments, the display layers 11, 21, 44, and 61 and the light-shielding pattern layers 12 and 62 may contain multiple types of electron-donating coloring matters that develop mutually different colors. In the third embodiment, the microcapsules 31C, 31M, and 31Y may each contain multiple types of electron-donating coloring matters. In the seventh embodiment, the first recording layer 72 and the second recording layer 74 may contain multiple types of electron-donating coloring matters that develop mutually different colors.

### Modification Example 7

In the first embodiment, a case where image elements 111A (that is, a first image 111) can be seen through light-transmitting parts 12TR (see the point of sight 2 in FIG. 2) when the display surface S1 is viewed from the vertical direction, and image elements 112A (that is, a second image 112 (see the points of sight 1 and 3 in FIG. 2)) can be seen through light-transmitting parts 12TR when the display surface S1 is viewed from the oblique direction with a specified angle ±θ was described, but the constitution of the image display element is not limited thereto. For example, a constitution may be one wherein image elements 111A (that is, a first image 111) can be seen through light-transmitting parts 12TR when the display surface S1 is viewed from the oblique direction with a first specified angle ±θ₁, and image elements 112A (that is, a second image 112) can be seen through light-transmitting parts 12TR when the display surface S1 is viewed from the oblique direction with a second specified angle ±θ₂ that differs from the first specified angle ±θ₁. Such a constitution may also be adopted in the second to eighth embodiments.

While embodiments and modification examples of the present disclosure have been described above in detail, the present disclosure is not limited to the above embodiments and modification examples, and various modifications based on the technical idea of the present disclosure can be made.

For example, the constitutions, methods, processes, shapes, materials, numerical values, and the like exemplified in the above embodiments and modification examples are only examples, and as necessary, different constitutions, methods, processes, shapes, materials, numerical values and the like may be used. The constitutions, methods, processes, shapes, materials, numerical values, and the like of the above embodiments and modification examples can be combined with each other as long as they do not deviate from the gist of the present disclosure.

In the numerical ranges stated in stages in the above embodiments and modification examples, the upper limit value or the lower limit value of the numerical range of a certain stage may be replaced with the upper limit value or the lower limit value in the numerical range of another stage. Unless otherwise specified, the materials exemplified in the above embodiments and modification examples may be used alone or two or more thereof may be used in combination.

In addition, the present disclosure may have the following constitutions.

(1) An image display element including:

a display layer configured to display first to n-th (where n is an integer of 2 or more) images;

a light-shielding pattern layer disposed opposite to the display layer and having alternately disposed light-shielding parts and light-transmitting parts; and

a transparent layer disposed between the display layer and the light-shielding pattern layer, wherein

the display layer contains a coloring matter, where the coloring matter forms the first to n-th images;

each of the first to n-th images is divided in a discrete manner corresponding to an arrangement pattern of the light-transmitting parts; and

an image visible through the light-shielding pattern layer changes depending on an angle from which the light-shielding pattern layer is viewed.

(2) The image display element according to (1), wherein the light-shielding pattern layer contains a coloring matter, and the coloring matter forms the light-shielding parts.

(3) The image display element according to (2), wherein the light-shielding pattern layer has a flat surface.

(4) The image display element according to (2) or (3), wherein the coloring matter in the light-shielding parts is in a color-developed state, and

the coloring matter in the light-transmitting parts is in a decolorized state.

(5) The image display element according to any one of (2) to (4), wherein the coloring matter in the display layer and the coloring matter in the light-shielding pattern layer is an electron-donating coloring matter, and

the display layer and the light-shielding pattern layer further contain an electron-accepting material.

(6) The image display element according to (5), wherein a reaction between the electron-donating coloring matter and the electron-accepting material is reversible.

(7) The image display element according to (5) or (6), wherein the display layer and the light-shielding pattern layer each contain a photothermal conversion material, and

the photothermal conversion material in the display layer and the photothermal conversion material in the light-shielding pattern layer have mutually different absorption wavelengths.

(8) The image display element according to any one of (1) to (7), wherein a ratio (W1:W2) between a width W1 of the light-shielding parts and a width W2 of the light-transmitting parts is about (n−1):1.

(9) The image display element according to any one of (1) to (8), wherein each of the first to n-th images is divided into discrete image elements corresponding to an arrangement pattern of the light-transmitting parts; and

image elements of the first to n-th images are arranged repeatedly in an in-plane direction of the display layer in an order of the image elements of the first to n-th images.

(10) The image display element according to any one of (1) to (9), wherein the light-shielding parts have an arrangement pattern of a striped pattern.

(11) The image display element according to any one of (1) to (10), wherein the display layer includes a first layer, a second layer, and a third layer, and

the first layer, the second layer, and the third layer contain coloring matters that develop mutually different colors.

(12) An image display element including: a display layer configured to display first to n-th (where n is an integer of 2 or more) images;

a light-shielding pattern layer disposed opposite to the display layer and having alternately disposed light-shielding parts and light-transmitting parts; and

a transparent layer disposed between the display layer and the light-shielding pattern layer, wherein

at least one of the display layer and the light-shielding pattern layer contains a coloring matter;

if the display layer contains the coloring matter, the coloring matter forms first to n-th images;

if the light-shielding pattern layer contains the coloring matter, the coloring matter forms the light-shielding parts;

each of the first to n-th images is divided in a discrete manner corresponding to an arrangement pattern of the light-transmitting parts; and

an image visible through the light-shielding pattern layer changes depending on an angle from which the light-shielding pattern layer is viewed.

(13) An image display element including:

a display layer;

a light-shielding pattern layer disposed opposite to the display layer and having alternately disposed light-shielding parts and light-transmitting parts; and

a first transparent layer disposed between the display layer and the light-shielding pattern layer, wherein

the display layer includes:

a first display layer configured to display a first image;

a second display layer disposed opposite to the first display layer and configured to display a second image; and

a second transparent layer disposed between the first display layer and the second display layer, wherein

the first display layer and the second display layer each contain a coloring matter, where the coloring matter forms a first image and the second image;

each of the first and second images is divided in a discrete manner corresponding to an arrangement pattern of the light-transmitting parts; and

an image visible through the light-shielding pattern layer changes depending on an angle from which the light-shielding pattern layer is viewed.

(14) A drawing body including the image display element according to any one of (1) to (13).

(15) A drawing body including:

a first recording layer;

a second recording layer disposed opposite to the first recording layer; and

a transparent layer disposed between the first recording layer and the second recording layer, wherein

the first recording layer includes a display part configured to display a first to n-th (where n is an integer of 2 or more) images;

the first recording layer contains a coloring matter, where the coloring matter forms first to n-th images;

the second recording layer includes a light-shielding pattern part disposed opposite to the display part and having alternately disposed light-shielding parts and light-transmitting parts;

each of the first to n-th images is divided in a discrete manner corresponding to an arrangement pattern of the light-transmitting parts; and

an image visible through the light-shielding pattern part changes depending on an angle from which the light-shielding pattern part is viewed.

(16) The drawing body according to (15), wherein the first recording layer includes at least one of photographs, characters, and patterns formed by the coloring matter.

(17) The drawing body according to (15) or (16), wherein the second recording layer contains a coloring matter, and the coloring matter forms the light-shielding parts.
(18) The drawing body according to (17), wherein the second recording layer includes at least one of photographs, characters, and patterns formed by the coloring matter in the second recording layer.

(19) A drawing body including:

a first recording layer;

a second recording layer disposed opposite to the first recording layer; and

a transparent layer disposed between the first recording layer and the second recording layer, wherein

the first recording layer includes a display part configured to display a first to n-th (where n is an integer of 2 or more) images;

the second recording layer includes a light-shielding pattern part disposed opposite to the display part and having alternately disposed light-shielding parts and light-transmitting parts;

at least one of the first recording layer and the second recording layer contains a coloring matter;

if the first recording layer contains the coloring matter, the coloring matter forms first to n-th images;

if the second recording layer contains a coloring matter, the coloring matter forms the light-shielding parts;

each of the first to n-th images is divided in a discrete manner corresponding to an arrangement pattern of the light-transmitting parts; and

an image visible through the light-shielding pattern part changes depending on an angle from which the light-shielding pattern part is viewed.

### REFERENCE SIGNS LIST

10, 20, 30, 40, 50, 60, 76, 82 Image display element

10A, 20A, 40A Laminate body

11, 21, 31, 44, 61 Display layer

11₁-11n Image element

11A, 21A, 41A First recording layer

12, 32, 62 Light-shielding pattern layer

12A, 42A Second recording layer

12BK, 62BK Light-shielding part

12TR, 62TR Light-transmitting part

13 Transparent layer

22 First layer

23 Second layer

24 Third layer

25, 26 Heat insulation layer

22A, 23A, 24A, 111B, 112B Color-developed part

22B, 23B, 24B Color-undeveloped part

43A Third recording layer

51 Back surface layer

70, 80 Card

71, 81 Supporting base

72 First recording layer

72A Display part 72A

72B Photograph

72C Background part

73 Transparent layer

74 Second recording layer

74A Light-shielding pattern part

74B Character drawing area

75, 84 Protective layer

83 Adhesive layer

111 First image

111A, 411A, 611A Image element

112 Second image

112A, 412A, 612A Image element

412A, 422A Separation part

S1 Display surface

S2 Back surface

L1, L2, L3, L4 Laser beam

1. An image display element comprising:
a display layer configured to display first to n-th (where n is an integer of 2 or more) images;
a light-shielding pattern layer disposed opposite to the display layer and having alternately disposed light-shielding parts and light-transmitting parts; and
a transparent layer disposed between the display layer and the light-shielding pattern layer, wherein
the display layer contains a coloring matter, where the coloring matter forms the first to n-th images;
each of the first to n-th images is divided in a discrete manner corresponding to an arrangement pattern of the light-transmitting parts; and
an image visible through the light-shielding pattern layer changes depending on an angle from which the light-shielding pattern layer is viewed.

2. The image display element according to claim 1, wherein the light-shielding pattern layer contains a coloring matter, and the coloring matter forms the light-shielding parts.

3. The image display element according to claim 2, wherein the light-shielding pattern layer has a flat surface.

4. The image display element according to claim 2, wherein the coloring matter in the light-shielding parts is in a color-developed state, and
the coloring matter in the light-transmitting parts is in a decolorized state.

5. The image display element according to claim 2, wherein the coloring matter in the display layer and the coloring matter in the light-shielding pattern layer is an electron-donating coloring matter, and
the display layer and the light-shielding pattern layer further contain an electron-accepting material.

6. The image display element according to claim 5, wherein a reaction between the electron-donating coloring matter and the electron-accepting material is reversible.

7. The image display element according to claim 5, wherein the display layer and the light-shielding pattern layer each contain a photothermal conversion material, and
the photothermal conversion material in the display layer and the photothermal conversion material in the light-shielding pattern layer have mutually different absorption wavelengths.

8. The image display element according to claim 1, wherein a ratio (W1:W2) between a width W1 of the light-shielding parts and a width W2 of the light-transmitting parts is about (n−1):1.

9. The image display element according to claim 1, wherein each of the first to n-th images is divided into discrete image elements corresponding to an arrangement pattern of the light-transmitting parts, and
image elements of the first to n-th images are arranged repeatedly in an in-plane direction of the display layer in an order of the image elements of the first to n-th images.

10. The image display element according to claim 1, wherein the light-shielding parts have an arrangement pattern of a striped pattern.

11. The image display element according to claim 1, wherein
the display layer includes a first layer, a second layer, and a third layer, and
the first layer, the second layer, and the third layer contain coloring matters that develop mutually different colors.

12. An image display element comprising:
a display layer configured to display first to n-th (where n is an integer of 2 or more) images;
a light-shielding pattern layer disposed opposite to the display layer and having alternately disposed light-shielding parts and light-transmitting parts; and
a transparent layer disposed between the display layer and the light-shielding pattern layer, wherein
at least one of the display layer and the light-shielding pattern layer contains a coloring matter;
if the display layer contains the coloring matter, the coloring matter forms first to n-th images;
if the light-shielding pattern layer contains the coloring matter, the coloring matter forms the light-shielding parts;
each of the first to n-th images is divided in a discrete manner corresponding to an arrangement pattern of the light-transmitting parts; and
an image visible through the light-shielding pattern layer changes depending on an angle from which the light-shielding pattern layer is viewed.

13. An image display element comprising:
a display layer;
a light-shielding pattern layer disposed opposite to the display layer and having alternately disposed light-shielding parts and light-transmitting parts; and
a first transparent layer disposed between the display layer and the light-shielding pattern layer, wherein
the display layer includes:
a first display layer configured to display a first image;
a second display layer disposed opposite to the first display layer and configured to display a second image; and
a second transparent layer disposed between the first display layer and the second display layer, wherein
the first display layer and the second display layer each contain a coloring matter, where the coloring matter forms a first image and the second image;
each of the first and second images is divided in a discrete manner corresponding to an arrangement pattern of the light-transmitting parts; and
an image visible through the light-shielding pattern layer changes depending on an angle from which the light-shielding pattern layer is viewed.

14. A drawing body comprising the image display element according to claim 1.

15. A drawing body comprising:
a first recording layer;
a second recording layer disposed opposite to the first recording layer; and
a transparent layer disposed between the first recording layer and the second recording layer, wherein
the first recording layer includes a display part configured to display a first to n-th (where n is an integer of 2 or more) images;
the first recording layer contains a coloring matter, where the coloring matter forms first to n-th images;
the second recording layer includes a light-shielding pattern part disposed opposite to the display part and having alternately disposed light-shielding parts and light-transmitting parts;
each of the first to n-th images is divided in a discrete manner corresponding to an arrangement pattern of the light-transmitting parts; and
an image visible through the light-shielding pattern part changes depending on an angle from which the light-shielding pattern part is viewed.

16. The drawing body according to claim 15, wherein the first recording layer includes at least one of photographs, characters, and patterns formed by the coloring matter.

17. The drawing body according to claim 15, wherein the second recording layer contains a coloring matter, and the coloring matter forms the light-shielding parts.

18. The drawing body according to claim 17, wherein the second recording layer includes at least one of photographs, characters, and patterns formed by the coloring matter in the second recording layer.

19. A drawing body comprising:
a first recording layer;
a second recording layer disposed opposite to the first recording layer;
a transparent layer disposed between the first recording layer and the second recording layer, wherein
the first recording layer includes a display part configured to display a first to n-th (where n is an integer of 2 or more) images;
the second recording layer includes a light-shielding pattern part disposed opposite to the display part and having alternately disposed light-shielding parts and light-transmitting parts;
at least one of the first recording layer and the second recording layer contains a coloring matter;
if the first recording layer contains the coloring matter, the coloring matter forms first to n-th images;
if the second recording layer contains a coloring matter, the coloring matter forms the light-shielding parts;
each of the first to n-th images is divided in a discrete manner corresponding to an arrangement pattern of the light-transmitting parts; and
an image visible through the light-shielding pattern part changes depending on an angle from which the light-shielding pattern part is viewed.
